(19) United States
(12) Patent Application Publication
(10) Pub. No.: US 2015/0274392 A1
(43) Pub. Date: Oct. 1, 2015

(54) TWO HANDLED SPOUTED PLASTIC GUSSETED POUCH FOR CONTAINING FLUID AND METHOD FOR MAKING

(71) Applicant: KV LOCK LLC, Miami, FL (US)

(72) Inventor: James F. PEASE, Lake in the Hills (FL)

(73) Assignee: KV LOCK LLC, Miami, FL (US)

(21) Appl. No.: 14/242,089

(22) Filed: Apr. 1, 2014

(51) Int. Cl. B65D 75/58; B65D 33/08; B31B 37/00; B31B 1/64; B31B 1/84; B31B 1/86; B65D 75/48; B31B 1/16

(52) U.S. Cl. CPC B65D 75/5877; B65D 75/48; B65D 33/08; B31B 1/16; B31B 1/64; B31B 1/84; B31B 1/86; B31B 37/00; B65D 2575/586

(57) ABSTRACT

A flexible plastic spouted container for holding flowable material and method of making. The container has a front and rear face and gussets that extend inwardly toward the longitudinal axis of the body. A spout is heat sealed into the front face adjacent the top. Handles are sealed top and bottom. Heat seals on the outer folds of the gussets extend from top to bottom with the heat seals extending further inwardly at the top portion than at the bottom portion. The heat seals are shaped to enable seal creep. Tye seals formed at the top sides of the container adjacent the spout seal the front face and rear face together with a portion of the gusset therebetween.

### BACKGROUND OF THE INVENTION

1. Field of Invention

The present invention relates to a two handled spouted plastic gusseted pouch for containing fluid and method for making.

2. Prior Art

Large containers for storing fluid food products, liquid or particulate, used in food service or in bulk product sales typically are provided in a rigid plastic container having a large opening. Transporting such containers is difficult. Removing all the contents is also difficult. U.S. Pat. Nos. 8,231,029 and 8,348,509 describe a type of large container or bag can be made out of a number of flexible plastic film panels having a rigid spout or fitment attached. A top and bottom handle is provided to assist in transporting and pouring. However, the design of the container makes it very difficult and very costly to manufacture.

### SUMMARY OF THE INVENTION

The container as described herein is a two handled spouted plastic gusseted pouch for containing fluid and fluid like materials and is made by a simple method that is relatively inexpensive. The container is a flexible plastic spouted container for holding flowable material comprising an elongated plastic closed film forming the body of the container having a front face and a rear face and left and right edge portions. Gussets are formed in the left and right edge portions of the body that extend inwardly toward the longitudinal axis of the body and include a front outer fold with the front face, a rear outer fold with the rear face and an inner fold. A spout is heat sealed into the front face adjacent the top thereof. A top handle is sealed on the top of the body, and a bottom handle is sealed on the bottom of said body. Heat seals are made on the outer folds of the gussets extending from top to bottom of the body wherein the heat seals extend further inwardly at the top portion of the body than at the bottom portion of said body and wherein the heat seals are shaped to enable seal creep. This is accomplished by using tapered heat sealing bars. Tye seals, located adjacent the spout, are formed at the top of the body sealing the front face and rear face together from the left and right edge portions inwardly adjacent the spout. The spout has a closure that is threaded on the spout. The spout also has a flange that is heat sealed into the front face of the body with the spout protruding therefrom. The flexible spouted container is composed of polyethylene. Alternatively, the flexible spouted container is composed of a structured film composed of a laminate of at least two layers with the bottom layer being polyethylene and the top layer being printable.

The method of making the container of flexible plastic material for holding flowable material comprising the steps of:

a. folding an elongated web of heat sealable flexible plastic material to produce a front face, a rear face and gussets formed in left and right edge portions of the web that extend inwardly toward the longitudinal axis of the web, the gussets including a front outer fold with the front face, a rear outer fold with the rear face and an inner fold juxtaposed to the longitudinal axis;

b. cutting off the front face to separate from the web;

c. punching a hole in the separated front face at a location representing the top portion of the container and inserting and heat sealing a flanged spout in the punched hole adjacent to the top thereof,;

d. rejoining the front face with the web and separately heat sealing all outer folds for predetermined container lengths, wherein each heat seal is carried out by tapered heat sealing bars with a taper from 2 degrees to 10 degrees, and wherein the width of the seals created are greater in the portion of the web representing the top portion of the container;

e. forming tye seals in top corner portions of the container to interconnect the gussets and the faces of the body together;

f. cross sealing the web at the leading and trailing portions of the web representing the top and bottom of the container, respectively, to form handles top and bottom;

g. punching slits in the handles to enable easy gripping; and

h. cutting the container from the web.

Step d. of the method is carried out using tapered heat seal bars having a 2 to 10 degree taper, with a preferred taper of 4 degrees. The web is polyethylene or alternatively a structured film composed of a laminate of at least two layers with the bottom layer being polyethylene and the top layer being printable.

### BRIEF DESCRIPTION OF THE DRAWINGS

FIG. 1 shows schematically a tube of plastic film that is being folded to form side gussets.

FIG. 2 shows schematically the slitting of the top portion of the folded film so that it can be fed separately to punch a hole and insert a rigid plastic spout having a flange that can be heat sealed to the top portion.

FIG. 3 shows schematically the top portion of the plastic film returned to the remainder of the folded plastic tube preparatory to heat sealing the folds of the gussets with the top and bottom portions of the plastic film.

FIG. 4 shows schematically the heat sealing of the folds of the gussets with the top and bottom portions of the plastic film.

FIG. 5 shows schematically the result of heat sealing of the folds and the heat sealing of the end portions of the plastic web that will form the top and bottom handles, with the heat sealing bars shown left and right.

FIG. 6 shows schematically the resulting pouch, the folds which have been heat sealed at the corners, the top and bottom cross seals made to define the handles top and bottom, the tye seals made on both sides of the pouch at the top heat sealing the gussets on each side together, and the handles slit or punched to define finger holes.

FIG. 7 shows schematically the side outer folds heat sealed together preparatory to making the tye seals.

FIG. 8 shows schematically a structured film being used to make the bag or pouch, with the structured film being composed of a laminate with the bottom layer being a heat sealable plastic film and the top layer being a printable plastic film, with the laminate being prepared with punched holes for heat sealing the gussets together to form the tye seals.

FIG. 9 is an enlarged showing schematically of a modification of the corner tye seal of the pouch.

FIG. 10 is an enlarged showing schematically of a further modification of the corner tye seal of the pouch.

FIG. 11 is an enlarged showing schematically of the tye seal of the laminated plastic film.

FIG. 12 shows schematically the two handled spouted plastic gusseted bag or pouch containing fluid and sitting on a flat surface.

### DETAILED DESCRIPTION OF INVENTION

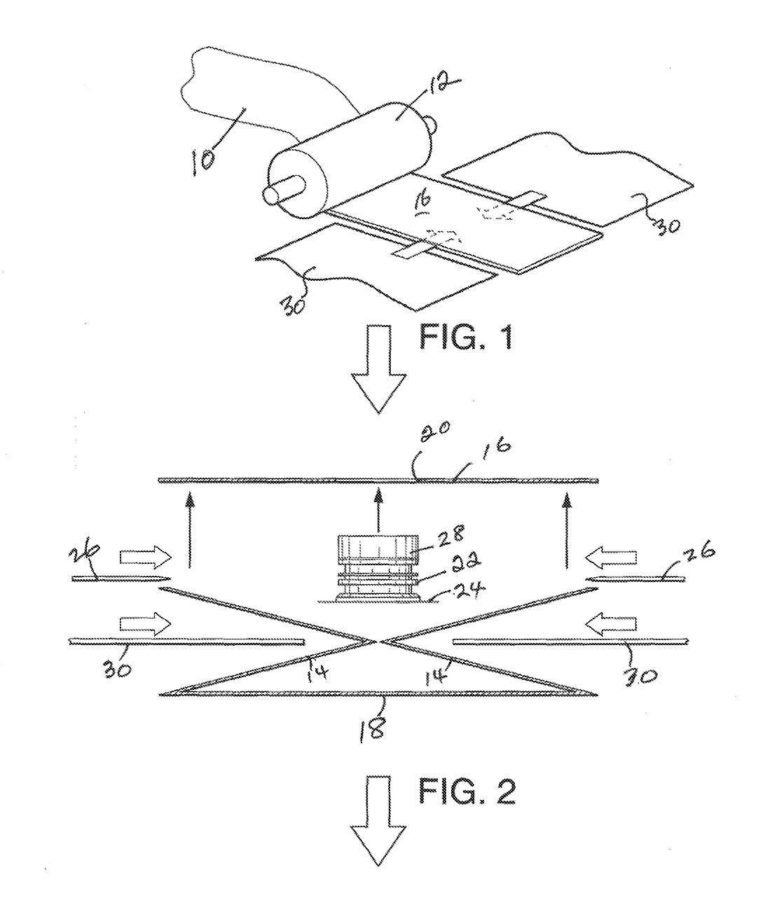

FIG. 1 shows schematically an elongated web or an elongated tube of plastic film 10 that is heat sealable, such as polyethylene, being fed from an unwinding area (not shown) Tye holes will be punched for structured film (to be explained hereinafter). Bag or pouch folding is produced by a pouch making machine to make the web or film 10 in its final folded shape. Hereinafter the bag or the pouch is generically referred to as either the bag or the pouch. The film 10 passes over a roller 12 and is folded to form gussets that extend to an inner fold 36 nearly to the middle of the web or tube of plastic film 10, juxtaposed to the longitudinal mid-line. The result is a folded gusseted structure as shown in FIG. 2 having a front face 16 and rear 18 with side gussets 14 extending inwardly to near the longitudinal axis of the web or tube.

In the next step of the method the folded film 10 is now presented to the flanged spout insert and film splitting area of the machine where the top layer of film, face 16, is cut off and redirected upwards in order to punch a hole 20. A flanged spout 22 is then inserted and the flange 24 is sealed to front face 16 in the punched hole. The top portion or front face 16 of the gusseted folded film 10 is slit off by knives 26 and led up so that a hole 20 can be punched in the top portion and a flanged rigid spout 22 having a cap 28 screwed thereon as a closure is inserted in the hole 20 and the flange 24 heat sealed to the top portion of the film so that it will eventually be at the top portion of the container (pouch) when completed. Rubber or Teflon plates 30 will be inserted in the gussets 14 during subsequent heat sealing.

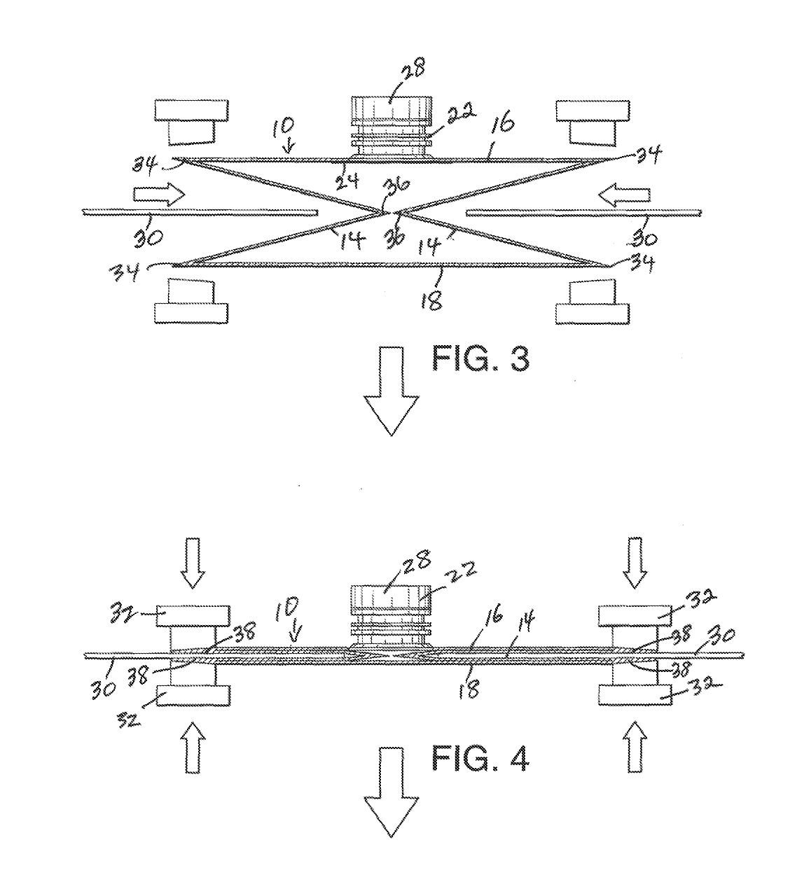

The next step in the method of making the pouch, as shown schematically in FIG. 3 is to advance the folded plastic web 10 to a longitudinal sealing area where side seals 38 of the bag are, as described hereinafter. Tye tacks then seal the gusset folds together on each side of the pouch. In this area of the bag, the side seals are shaped in 2 directions, so they can project into the pouch, then taper out at the point of compression when dropping. This construction prevents fracture of the bag from the internal force of product pushing out in a hydraulic action from dropping; this relief allows for the seal to migrate a small amount and assist in preventing fracture. The actual seal bars are shaped for this and the sealing surfaces are tapered, enabling the physical seal to creep a small amount verses fracturing or ripping the seal out. As shown in FIGS. 2, 3 and 4 rubber or Teflon sheets 30 are inserted in the gussets 14 to aid in cushioning when side heat seal bars 32 are compressed.

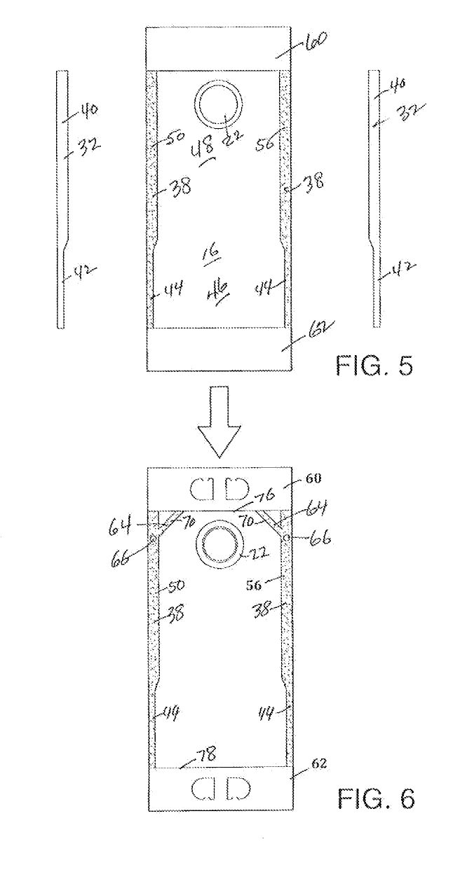

Profiled side heat sealing bars 32 are shown in FIG. 3 in position to heat seal the outer folds 34 of the gussets 14. The bars 32 are shown in FIG. 4 as closed and heat sealing the outer folds 34 of the gussets 14 producing seals 38. The resulting partially completed pouch is shown in FIG. 5 where one can see the profiled shape of the side heat sealing bars 32; the top portion 40 of the bars 32 have a wider sealing surface than the bottom portion 42 of the sealing bars 32 resulting in the bottom portion 46 of the resulting pouch having a greater cross section and therefore, will accommodate a greater cross sectional quantity of fluid in the bottom portion 46 relative to the top portion 48 of the pouch. This will shrink the sides as the bag or pouch is filled and the result will enable the bag or pouch to stand up straighter and not tip over. The wider seal 50 in the upper portion 48 will extend from 65% to 80% of the overall length of the heat seals 38, whereas the lower portion 44 will extend from 20% to 35% of the overall length of heat seals 38. In this section, the seal bars 32 are shaped in 2 directions; one of the shapes will redistribute the liquid upwards when the bag is dropped on end. The other shape is in the seal face direction. A 4 degree taper is added to the seal bars 32 and this will enable creating a weak to strong seal and aid in the dropping process to prevent the bag from splitting from the force; a controlled creep in the seal is created acting like a shock absorber. The working surface of the side heat sealing bars can be tapered from 2 to 10 degrees, but a 4 degree taper is preferred.

Further, in FIG. 5 one can see that the capped spout 22 is situated near the top of the pouch and there are portions 60, 62 of the tubular web that are delineated for the top handle and bottom handle, respectively.

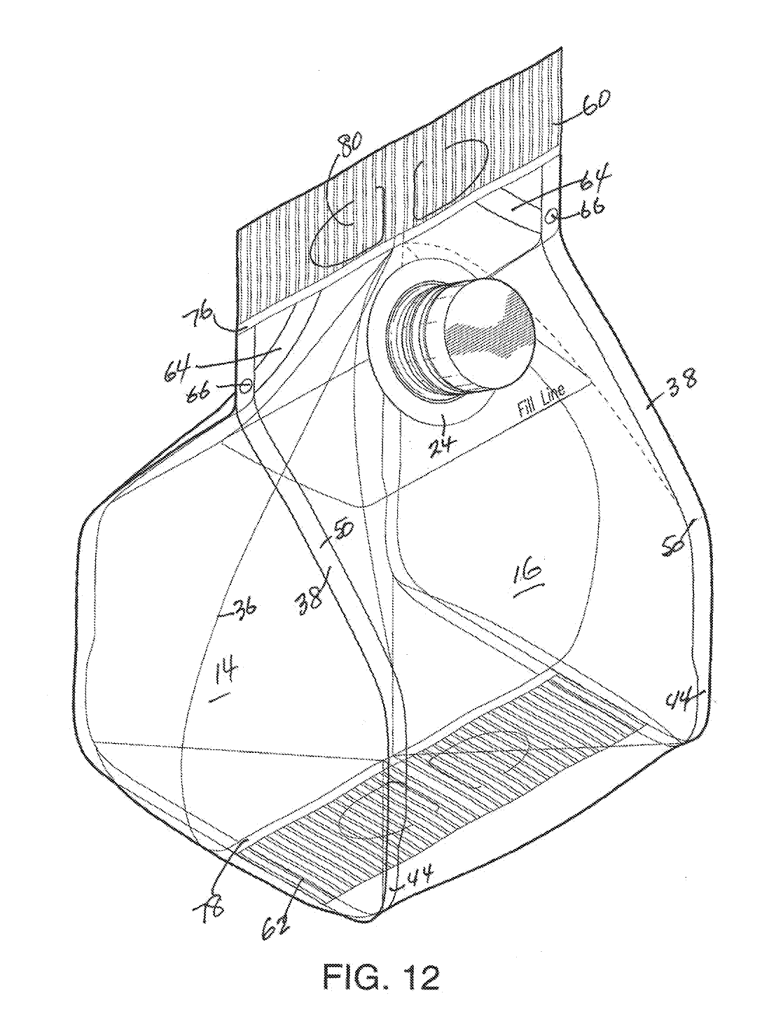

On unstructured film and on structured films, it is necessary to bring the gussets 14 together and make the seals pull up on themselves; this will make the bag standup and prevent a wobble in the bag from the material. With extra material on the sides, a 4-post strength in the bag is created by tacking each side of the top together, called “tye seal”. The tye seals 64 are located at the top of the pouch on each side, and this will force the sides to shrink and make the pouch standup without any other support by means of the product inside the pouch, as is particularly evident from FIG. 12 showing a filled container (bag or pouch).

The tye seals 64 are used on polyethylene film (heat sealable) containers and structured film containers (containing a bottom layer of a heat sealable material, such as polyethylene and a top laminated layer or non-heat sealable material) to add strength to the bag and make a square container. The tye seals 64 incorporated with a tack hole 66 will enable for structured films to act in a similar way as polyethylene films to maintain the geometry of the bag or pouch (container). The tye seals 64 on both sides of the pouch bring the gussets 14 together and create less seal distance to the volume of the bag and pull the bag or pouch to standup and be rigid verses tipping over. The shaped side seal 38 design will allow for seal creep and the hydraulic force of the liquid to move in an upward, not only outward motion, to prevent fracturing of the bag at the highest stress level located lower in the bag. The shaped side seals 38 at the four corners of the pouch, sealing the outer folds 34 of the gussets 14 provide the highest compression at the areas of the bag or pouch for expansion during dropping, also the seal bars 32 are tapered as mentioned and create a creeping seal and prevent fracturing of the bag or pouch. The tye seals 64 can be any shape as long as they are designed to tack or heat seal the top part of each gusset 14 together with the front face 16 and rear face 18 when sealed. Normally all layers will seal together easily with polyethylene structures or other heat sealable films, as the bag or pouch (container) is so designed. However, when one is using a structured film, a small tack hole 66 will be integrated in the process so enable the outer folds 34 to overlap and expose a polyethylene sealing area that is necessary to complete tacking the top of the pouch together as indicated.

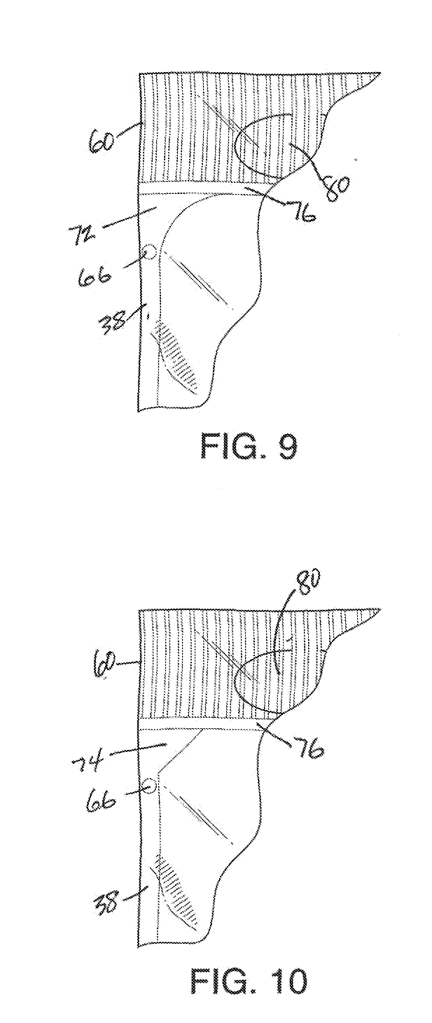

The tye seals 64 are produced in the cross sealing area following the heat sealing of the outer folds 34 of the gusseted pouch or bag as shown in FIGS. 3-5. The tye seals 64 are shown in FIG. 6 as diagonal strips 70 extending from the top of the bag or pouch to the side seals 38 and that portion of the side seals 38 that lies between the intersection of the diagonal seals and the top of the container. Thus, the tye seals 64 consist of the top corners of the bag or pouch on both sides of the bag or pouch. In this area, the top corner portions of the gussets 14 are sealed together with the front face 16 and rear face 18 down to opposite the capped spout 22. In this machine area, the tye seals 64 are produced for added strength. The shape of the tye seals can be any shape from a diagonal seal 70 shown in FIGS. 5 and 6, to a curved seal 72 shown in FIG. 9, to a solid seal 74 shown in FIG. 10; the main purpose being to ensure the tack holes or tack area is sealed together so when the bag is filled with liquid, it will stand up. The top handle and bottom handle seals 76 and 78 are also added at this time, as shown in FIG. 6 by means of cross sealing the layers of plastic film 10 together above and below the body of the container. Now the bag or pouch is punched to create slits 80 that provide finger openings with tabs in the now formed handles 60, 62 as shown in FIG. 6, and the bag is cut to the correct size based on the amount of product customer needs, from 0.5 gal to 20 gal.

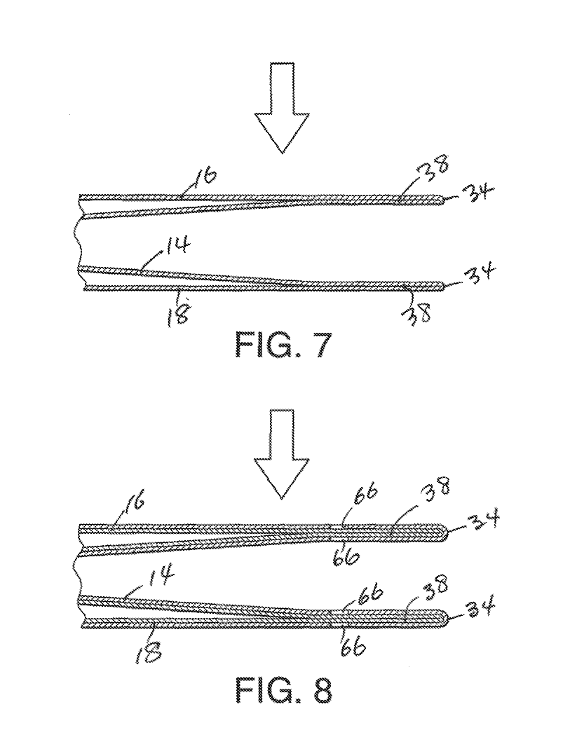

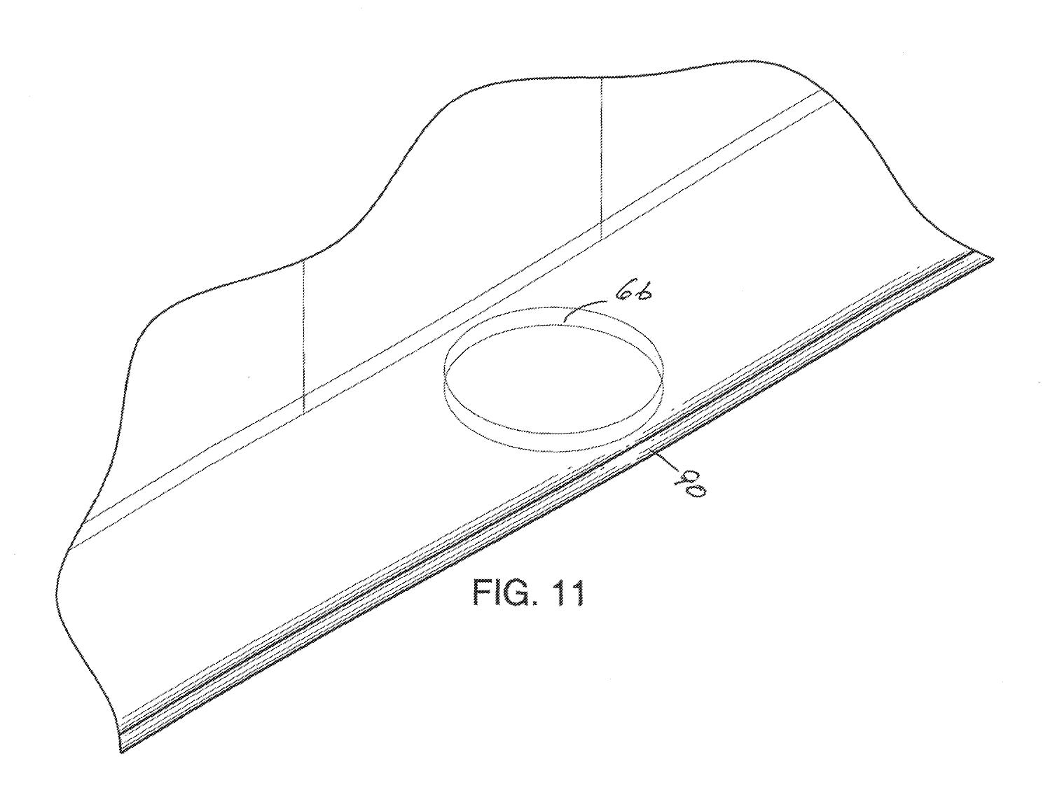

FIG. 7 is a fragmentary view of a polyethylene bag or pouch showing particularly a front outer fold and a back outer fold 34 of a gusset 14 on one side of the bag or pouch. As the bag or pouch is only polyethylene, it is possible to heat seal the outer folds 34 of gusset 14 together at the corners of the bag or pouch both at the front face 16 and rear face 18. However, when using a structured film to form the bag or pouch, it is necessary, as shown in FIGS. 8 and 11 to punch tack holes 66 by removing spots of the top laminated film in the outer folds of the gussets 14 and front and rear faces in order to expose the underlying polyethylene and to be able to seal the gusset outer folds 14 together on both sides of the bag or pouch and to the front face 16 and rear face 18 to form the tye seals 64 at the top corners of the pouch.

FIG. 11 shows the a tack hole 66 that are necessary to heat seal the outer folds 34 of the gussets 14 when creating the side seals 38 and the tye seals 64 for bags or pouches made from structured film 90. FIG. 12 shows in perspective a completed spouted plastic bag or pouch that has been filled with a liquid to the “Fill Line” and placed on a flat surface.

What is claimed is:

1. A flexible plastic spouted container for holding flowable material comprising an elongated plastic closed film forming the body of the container having a front face and a rear face and left and right edge portions, gussets formed in the left and right edge portions of the body that extend inwardly toward the longitudinal axis of the body and include a front outer fold with the front face, a rear outer fold with the rear face and an inner fold, a spout heat sealed into the front face adjacent the top thereof, a top handle sealed on the top of the body, a bottom handle sealed on the bottom of said body, heat seals on the outer folds of the gussets extending from top to bottom of said body wherein the heat seals extend further inwardly at the top portion of the body than at the bottom portion of said body and wherein the heat seals are shaped to enable seal creep, and tye seals formed at the top of the body adjacent the spout sealing the front face and rear face together with a portion of the gusset therebetween from the left and right edge portions inwardly.

2. The flexible plastic spouted container according to claim 1 wherein the spout has a closure.

3. The flexible plastic spouted container according to claim 2 wherein the closure of the spout is threaded on the spout.

4. The flexible plastic spouted container according to claim 1 wherein the spout has a flange that is heat sealed into the front face of the body with the spout protruding therefrom.

5. The flexible plastic spouted container according to claim 1 wherein the body is composed of polyethylene.

6. The flexible plastic spouted container according to claim 1 wherein the body is composed of a structured film composed of a laminate of at least two layers with the bottom layer being polyethylene and the top layer being printable.

7. The flexible plastic spouted container according to claim 1 wherein the heat seal at the outer fold of each gusset from the bottom of the body extends upwardly for up to 35% of the length of the body.

8. A method of making a container of flexible plastic material for holding flowable material comprising the steps of:
a. folding an elongated web of heat sealable flexible plastic material to produce a front face, a rear face and gussets formed in left and right edge portions of the web that extend inwardly toward the longitudinal axis of the web, said gussets including a front outer fold with the front face, a rear outer fold with the rear face and an inner fold;
b. cutting the front face to separate from the web;
c. punching a hole in the separated front face at a location representing the top portion of the container and inserting and heat sealing a flanged spout in the punched hole adjacent to the top thereof,;
d. rejoining the front face with the web and separately heat sealing all outer folds for predetermined container lengths, wherein each heat seal is carried out by tapered heat sealing bars with a taper, and wherein the width of the seals created are greater in the portion of the web representing the top portion of the container;
e. forming tye seals in top corner portions of the container to interconnect the gussets together;
f. cross sealing the web at the leading and trailing portions of the web representing the top and bottom of the container to form handles top and bottom;
g. punching the handles to enable easy gripping; and
h. cutting the container from the web.

9. The method according to claim 8 wherein step d. is carried out using tapered heat seal bars having from 2 degrees to 10 degrees taper.

10. The method according to claim 9 wherein step d. is carried out using tapered heat seal bars having a 4 degree taper.

11. The method according to claim 8 wherein the web is polyethylene.

12. The method according to claim 8 wherein the web is a structured film composed of a laminate of at least two layers with the bottom layer being heat sealable and the top layer being printable.

13. The method according to claim 8 wherein step d is carried out so that the lower portion of each heat seal is narrower than the heat seal of the upper portion.

14. The method according to claim 13 wherein the lower portion of each heat seal constitutes up to 35% of the predetermined container length.
